(19) United States
(12) Patent Application Publication
(10) Pub. No.: US 2003/0069366 A1
(43) Pub. Date: Apr. 10, 2003

(54) Urethane oligomers of heterotelechelic amine functional polyolefins

(76) Inventors: Robert J. Letchford, Cherryville, NC (US); Thorsten Brockmann, Hilton Head, SC (US); John F. Engel, Belmont, NC (US); James A. Schwindeman, Gastonia, NC (US); John L. Greak, Shelby, NC (US)

Correspondence Address: MYERS BIGEL SIBLEY & SAJOVEC, PO BOX 37428, RALEIGH, NC, 27627, US

(21) Appl. No.: 10/245,451

(22) Filed: Sep. 17, 2002

Related U.S. Application Data
(60) Provisional application No. 60/322,718, filed on Sep. 17, 2001.

(51) Int. Cl. C08F 36/00

(52) U.S. Cl. 525/331.9

(57) ABSTRACT

The present invention provides urethane oligomers of α, [symbol] functional heterotelechelic polymers, and in particular heterotelechelic polyolefins having at least one terminal hydroxyl functionality and one other terminal functional group which is different from the hydroxyl functionality, such as an amine functional group. The oligomers of the invention can exhibit toughness, chemical resistance and other desired properties. The oligomers can also exhibit improved flexibility and impact resistance, due to the incorporation of the polyolefinic backbone. Thus the oligomers can be used in a variety of applications, including without limitation coatings, sealants, adhesives, and composites (prepregs).

The heterotelechelic polyolefin is advantageously prepared via anionic polymerization using lithium initiators, and in particular functionalized lithium initiators having a protected hydroxy functionality as known in the art. The resulting living chain end can be functionalized using an amine functionalized electrophile, in which typically the amine group is protected. Alternatively amine protected functionalized initiators can used and the resulting living polymer functionalized using a hydroxy functionalizing electrophile. Protecting groups, when present, are removed to liberate the desired functionalities.

### CROSS-REFERENCE TO RELATED APPLICATIONS

This application is related to commonly owned copending provisional application Serial No. 60/322,718, filed Sep. 17, 2001, and claims the benefit of the earlier filing date of this application under 35 U.S.C. §19(e).

### FIELD AND BACKGROUND OF THE INVENTION

The present invention relates to urethane oligomers of amine and hydroxy terminated polyolefins and methods of making and using the same.

### SUMMARY OF THE INVENTION

The present invention is directed to unique compounds having various desirable yet contradictory properties. In particular, the present invention provides urethane oligomers of α,ω functional heterotelechelic polymers, and in particular heterotelechelic polyolefins having at least one terminal hydroxyl functionality and one other terminal functional group which is different from the hydroxyl functionality, such as an amine functional group. The oligomers of the invention can exhibit toughness, chemical resistance and other desired properties. The oligomers can also exhibit improved flexibility and impact resistance, due to the incorporation of the polyolefinic backbone. Thus the oligomers can be used in a variety of applications, including without limitation coatings, sealants, adhesives, and composites (prepregs).

The heterotelechelic polyolefin is advantageously prepared via anionic polymerization using lithium initiators, and in particular functionalized lithium initiators having a protected hydroxy functionality as known in the art. The resulting living chain end can be functionalized using an amine functionalized electrophile, in which typically the amine group is protected. Alternatively amine protected functionalized initiators can used and the resulting living polymer functionalized using a hydroxy functionalizing electrophile. Protecting groups, when present, are removed to liberate the desired functionalities.

The heterotelechelic polyolefin is reacted with any suitable polyfunctional isocyanate capable of reacting with a hydroxyl or amine terminated polyolefin. One exemplary polyfunctional isocyanate is the isocyanaurate of hexamethylene diisocyanate.

The heterotelechelic polyolefins are preferably substantially hydrogenated, so that at least about 70%, or more, of the carbon-carbon double bonds are saturated. The inventors have found that the use of hydrogenated heterotelechelic polyolefins can provide the benefit of improved thermal oxidative stability and UV stability. Further, the presence of the polyolefin chain can provide other useful properties to the resulting oligomers, such as elastomeric properties and improved adhesion of the oligomers to polyolefin substrates.

The present invention also provides methods for making the oligomers of the invention. Generally the oligomers can be prepared by reacting a polyisocyanate with a heterotelechelic polyolefin as described herein. The reaction can take place at temperatures ranging from about 0 to about 150° C. for at least about 0.5 hour, and up to 8 hours, although temperature and reaction times outside of these ranges can be employed as well.

The present invention also includes methods of chain extending or “advancing” the oligomers of the invention to increase solubility thereof. In this aspect of the invention the oligomers are further reacted with a polyfunctional compound, such as polyols and/or additional diepoxides.

### BRIEF DESCRIPTION OF THE DRAWINGS

FIG. 1 illustrates the synthesis of α-hydroxyl, ω-sec-amine functional polyolefin.

FIG. 2 illustrates the synthesis of the trifunctional hydroxyl polyolefin urethane oligomer.

FIG. 3 illustrates the synthesis of the trifunctional sec-amine polyolefin urethane oligomer.

FIG. 4 illustrates the synthesis of the trifunctional sec-amine polyolefin urethane oligomer-acrylic adduct.

FIG. 5 illustrates the synthesis of the Michael addition adduct of polyoxyalkylene diacrylate with heterotelechelic α-secondary amine, ω-hydroxy polyolefin.

FIG. 6 illustrates the sythesis of the trifunctional acrylated polyolefin urethane oligomer.

FIG. 7 illustrates the synthesis of the trifunctional sec-amine polyolefin urethane oligomer-epoxy adduct.

FIG. 8 illustrates the synthesis of the heterotelechelic polymer with primary and secondary hydroxyl functionality.

FIG. 9 illustrates the synthesis of the trifunctional sec-hydroxyl polyolefin urethane oligomer.

### DETAILED DESCRIPTION OF THE INVENTION

The present invention now will be described more fully hereinafter, in which preferred embodiments of the invention are described. This invention may, however, be embodied in many different forms and should not be construed as limited to the embodiments set forth herein; rather, these embodiments are provided so that this disclosure will be thorough and complete, and will fully convey the scope of the invention to those skilled in the art.

The amine-terminated polyolefins are prepared by methods known to those skilled in the art such as those described in U.S. Pat. No. 5,910,547 to Schwindeman et al.; U.S. Pat. No. 6,160,054 to Schwindeman et al.; U.S. Pat. No. 6,197,891 to Schwindeman et al.; and U.S. patent application Ser. No. 09/256,737, filed Feb. 24, 1999, to Schwindeman et al, now U.S. Pat. No. 6,121,474, issued Sep. 19, 2000, which are all incorporated herein by reference in their entirety. See also U.S. patent application Ser. No. 09/665,528, filed Sep. 19, 2000, to Brockmann et al., which is also incorporated herein by reference in its entirety.

For example, a protected hydroxyl functional lithium anionic polymerization initiator, such as described in the above-noted references, may be used to polymerize one or more suitable monomer(s) capable of anionic polymerization, including conjugated alkadienes, alkenylsubstituted aromatic hydrocarbons, and mixtures thereof. An exemplary protected hydroxyl functionalized initiator has the formula:

M-Qₙ-Z-O-(A-R¹R²R³)

wherein:

M is an alkali metal selected from the group consisting of lithium, sodium and potassium;

Z is a branched or straight chain hydrocarbon connecting group which contains 3-25 carbon atoms optionally substituted with aryl or substituted aryl containing lower alkyl, lower alkylthio, or lower dialkylamino groups;

Q is a saturated or unsaturated hydrocarbyl group derived by incorporation of one or more conjugated diene hydrocarbons, one or more alkenylsubstituted aromatic hydrocarbons, or mixtures thereof;

n is a number from 0 to 5; and

(A-R¹R²R³)₂ is a protecting group in which A is an element selected from Group IVa of the Periodic Table of the Elements; and R¹, R², and R³ are independently selected from the group consisting of hydrogen, alkyl, substituted alkyl, aryl, substituted aryl, cycloalkyl, substituted cycloalkyl.

Unless otherwise indicated, as used herein, the term “alkyl” refers to straight chain and branched C1-C25 alkyl. The term “substituted alkyl” refers to C1-C25 alkyl substituted with one or more lower C1-C10 alkyl, lower alkoxy, lower alkylthio, or lower dialkylamino. The term “cycloalkyl” refers to C3-C12 cycloalkyl. The term “substituted cycloalkyl” refers to C3-C12 cycloalkyl substituted with one or more lower C1-C10 alkyl, lower alkoxy, lower alkylthio, or lower dialkylamino. The term “aryl” refers to C5-C25 aryl having one or more aromatic rings, each of 5 or 6 carbon atoms. Multiple aryl rings may be fused, as in naphthyl or unfused, as in biphenyl. The term “substituted aryl” refers to C5-C25 aryl substituted with one or more lower C1-C10 alkyl, lower alkoxy, lower alkylthio, or lower dialkylamino. Exemplary aryl and substituted aryl groups include, for example, phenyl, benzyl, and the like.

The resultant living polymer will include a protected hydroxyl functional group at one terminus and a living chain end at the other terminus. The living chain end may then be functionalized with an amine functional electrophile. Exemplary amine functional electrophiles include without limitation those described in the aforementioned references, as well as other amine electrophiles as known in the art suitable for providing an amine functionality to an living polymer chain end. Such functionalizing agents can have the following structure:

X—Y—W—(B—R⁴R⁵R⁶)ₖ

wherein:

X is halogen, preferably chloride, bromide or iodide;

Y is branched or straight chain hydrocarbon connecting groups which contains 1-25 carbon atoms optionally substituted with aryl or substituted aryl containing lower alkyl, lower alkylthio, or lower dialkylamino groups;

W is nitrogen;

(B—R⁴R⁵R⁶)ₖ is a protecting group in which B is an element selected from Group IVa of the Periodic Table of the Elements; and R⁴, R⁵ and R⁶ are independently selected from the group consisting of hydrogen, alkyl, substituted alkyl, aryl, substituted aryl, cycloalkyl and substituted cycloalkyl or R⁶ is optionally a —(CR⁷R⁸)₁— group linking two B wherein R⁷ and R⁸ are each independently selected from the group consisting of hydrogen, alkyl, substituted alkyl, aryl, substituted aryl, cycloalkyl, and substituted cycloalkyl, and 1 is an integer from 1 to 7; and

k is 2.

Thus the skilled artisan will appreciate that when W is nitrogen, R⁶ as used herein includes the group

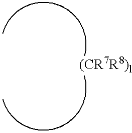

linking two B groups.

The protecting groups, when present, can be removed using techniques known in the art, also as described in the aforementioned references. Residual carbon-carbon double bonds can be hydrogenated until at least 70% or more of the aliphatic unsaturation has been saturated.

Alternatively the heterotelechelic polymers may be prepared using a lithium initiator having a protected amine group, as known in the art and as described in the foregoing references. Such protected amine functionalized initiators generally have a structure similar to that described above with regard to the protected hydroxyl functionalized initiators, except that the protected functional group is a nitrogen group, instead of oxygen. The resultant amine functionalized living polymer can then be reacted with a suitable electrophile for providing a terminal hydroxyl group thereto, such as a protected hydroxyl functionalized electrophile, ethylene oxide, and the like. Exemplary protected hydroxyl functional electrophiles include compounds similar to the electrophiles described above, except that the functional group W is oxygen and k is one.

Examples of suitable conjugated alkadienes include, but are not limited to, 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene and mixtures thereof.

Examples of polymerizable alkenylsubstituted aromatic hydrocarbons include, but are not limited to, styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene and mixtures of these, as well as alkyl, cycloalkyl, aryl, alkylaryl and arylalkyl derivatives thereof in which the total number of carbon atoms in the combined hydrocarbon constituents is generally not greater than 18. Examples of these latter compounds include 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene and 4,5-dimethyl-1-vinylnaphthalene. U.S. Pat. No. 3,377,404, incorporated herein by reference in its entirety, discloses suitable additional alkenylsubstituted aromatic compounds.

Examples of methods to hydrogenate the polymers of this invention are described in Falk, Journal of Polymer Science: Part A-1, vol. 9, 2617-2623 (1971), Falk, Die Angewandte Chemie, 21, 17-23 (1972), U.S. Pat. Nos. 4,970,254, 5,166,277, 5,393,843, 5,496,898, and 5,717,035. The hydrogenation of the functionalized polymer is conducted in situ, or in a suitable solvent, such as hexane, cyclohexane or heptane. This solution is contacted with hydrogen gas in the presence of a catalyst, such as a nickel catalyst. The hydrogenation is typically performed at temperatures from 25° C. to 150° C., with a archetypal hydrogen pressure of 15 psig to 1000 psig. The progress of this hydrogenation can be monitored by InfraRed (IR) spectroscopy or Nuclear Magnetic Resonance (NMR) spectroscopy. The hydrogenation reaction is conducted until at least 70% of the aliphatic unsaturation has been saturated. The hydrogenated functional polymer is then recovered by conventional procedures, such as removal of the catalyst with aqueous acid wash, followed by solvent removal or precipitation of the polymer.

The polymerization is preferably conducted in a non-polar solvent such as a hydrocarbon, since anionic polymerization in the presence of such non-polar solvents is known to produce polyenes with high 1,4-contents from 1,3-dienes. Inert hydrocarbon solvents useful in practicing this invention include but are not limited to inert liquid alkanes, cycloalkanes and aromatic solvents and mixtures thereof. Exemplary alkanes and cycloalkanes include those containing five to 10 carbon atoms, such as pentane, hexane, cyclohexane, methylcyclohexane, heptane, methylcycloheptane, octane, decane and the like and mixtures thereof. Exemplary aryl solvents include those containing six to ten carbon atoms, such as toluene, ethylbenzene, p-xylene, m-xylene, o-xylene, n-propylbenzene, isopropylbenzene, n-butylbenzene, and the like and mixtures thereof.

Polar solvents (modifiers) can be added to the polymerization reaction to alter the microstructure of the resulting polymer, i.e., increase the proportion of 1,2 (vinyl) microstructure or to promote functionalization or randomization. Examples of polar modifiers include, but are not limited to: diethyl ether, dibutyl ether, tetrahydrofuran (THF), 2-methyltetrahydrofuran, methyl tert-butyl ether (MTBE), diazabicyclo[2.2.2]octane (DABCO), triethylamine, tri-n-butylamine, N,N,N′,N′-tetramethylethylenediamine (TMEDA), and 1,2-dimethoxyethane (glyme). The amount of the polar modifier added depends on the vinyl content desired, the nature of the monomer, the temperature of the polymerization, and the identity of the polar modifier.

The heterotelechelic functional polymer is preferably a hydrogenated polybutadiene, a hydrogenated polyisoprene, or a hydrogenated copolymer of butadiene and isoprene. Preferably, at least about 70%, more preferably at least about 90%, and most preferably up to about 98% of the unsaturated carbon-carbon double bonds in the polymers or copolymers are hydrogenated.

The molecular weight of the amine functional polymer can range from about 1000 to about 200,000, preferably from about 1500 to about 20,000 and more preferably from about 3000 to about 5000. The functionality of the α,ω functional heterotelechelic polyolefin is preferably about 1.0 amine groups per chain. The amine function may be primary, secondary or tertiary, but primary or secondary amine function is preferred.

The heterotelechelic polymers can be represented generally by the formula Q-R₁-Q, wherein R₁ is a polyolefin, at least one Q is a hydroxyl group and the other of said Q is an amine group. In one advantageous embodiment of the invention, the heterotelechelic polymers can be represented generally by the formula

T(H)ₘ-Z-Qₙ-C—Y—W(H)ₖ

wherein:

C represents a hydrogenated or unsaturated block derived by anionic polymerization of one or more conjugated diene hydrocarbons, one or more alkenylsubstituted aromatic hydrocarbons, or mixtures thereof;

Y is a branched or straight chain hydrocarbon connecting group which contains 1-25 carbon atoms optionally substituted with aryl or substituted aryl containing lower alkyl, lower alkylthio, or lower dialkylamino groups;

Z is a branched or straight chain hydrocarbon connecting groups which contains 3-25 carbon atoms optionally substituted with aryl or substituted aryl containing lower alkyl, lower alkylthio, or lower dialkylamino groups;

Q is a saturated or unsaturated hydrocarbyl group derived by incorporation of one or more conjugated diene hydrocarbons, one or more alkenylsubstituted aromatic hydrocarbons, or mixtures thereof;

n is a number from 0 to 5;

T and W are each independently selected from oxygen and nitrogen, with the proviso that at least one of T or W is oxygen and the other of T or W is nitrogen; and

k and m are 1 when T or W is oxygen, and 2 when T or W is nitrogen.

The isocyanates can be any suitable polyisocyanate capable of reacting with the amine and/or hydroxy terminus of the polyolefins. Such polyisocyanates are known in the art and are commercially available.

Polyfunctional isocyanates suitable for practice of this invention include those derived from monomeric isocyanates corresponding to the formula, R(NCO)ₙ, wherein R represents an aliphatic, cycloaliphatic, or aromatic hydrocarbon containing 4 to 40 carbon atoms. Examples of diisocyanate compounds suitable for use in the invention include, but are not limited to, 1,4-diisocyanatobutane, 1,5-diisocyanato-2,2-dimethylpentane, 2,2,4- and 2,4,4-trimethyl-1,6-diisocyananatohexane, 1,10-diisocyananatodecane, 4,4′-diisocyanatodicyclohexylmethane, 1,6-hexamethylene diisocyanate, 1,12-dodecane diisocyanate, cyclobutane-1,3-diisocyanate, cyclohexane-1,3- and/or 1,4-diisocyanate, 1-isocyanato-3,3,5-trimethyl-5-isocyanatomethyl cyclohexane(isophorone or IPDI), 2,4- and/or -2,6-hexahydrotoluylene diisocyanate, hexahydro-1,3- and/or -1,4-phenylene diisocyanate, perhydro-2,4′- and/or -4,4′diphenylmethane diisocyanate, 1,3- and/or -1,4-phenylene diisocyanate, 2,4- and/or -2,6-toluylene diisocyanate, diphenyl methane-2,4′- and/or -4,4′-diisocyanate, naphthylene-1,5-diisocyanate, triphenyl methane-4,4′,4″-triisocyanate and polyphenyl polymethylene polyisocyanates obtained by phosgenating aniline/formaldehyde condensation products.

Polyfunctional isocyanate adducts containing allophanate, isocyanaurate, or biuret groups are also suitable for the practice of this invention. Polyisocyanate adducts containing biuret groups may be prepared from the previously mentioned diisocyanates according to the processes disclosed in U.S. Pat. Nos. 3,124,605; 3,358,010; 3,644,490; 3,862,973; 3,903,126; 3,903,127; 4,051,165; 4,147,714; or 4,220,749 by using coreactants such as water, tertiary alcohols, primary and secondary monoamines, and primary and/or secondary diamines.

Polyisocyanate adducts containing allophanate groups may be prepared from the previously mentioned diisocyanates according to processes disclosed in U.S. Pat. Nos. 3,769,318 and 4,160,080, British Pat. No. 994,890 and German Offenlegungsschrift No. 2,020,645.

Polyisocyanate adducts containing isocyanaurate groups may be prepared by trimerizing the previously mentioned diisocyanates in accordance with the processes disclosed in U.S. Pat. Nos. 3,487,080; 3,919,218; 4,040,992; 4,288,586; and 4,324,879; German Offenlegungsschrift No. 2,325,826; and British Pat. No. 1,465,812. In addition to the isocyanaurate trimers, higher homologues, such as pentamers and hexamers of the same molecular species are produced in these processes.

Polyisocyanate adducts containing urea and/or urethane groups and based on the reaction product of the previously mentioned diisocyanates and compounds containing 2 or more isocyanate-reactive hydrogens may be prepared according to the process disclosed in U.S. Pat. No. 3,183,112. For example a polyfunctional isocyanate may be prepared by reaction of glycols, triols or higher polyhydric alcohols, such as trimethylol propane, with the previously mentioned diisocyanates.

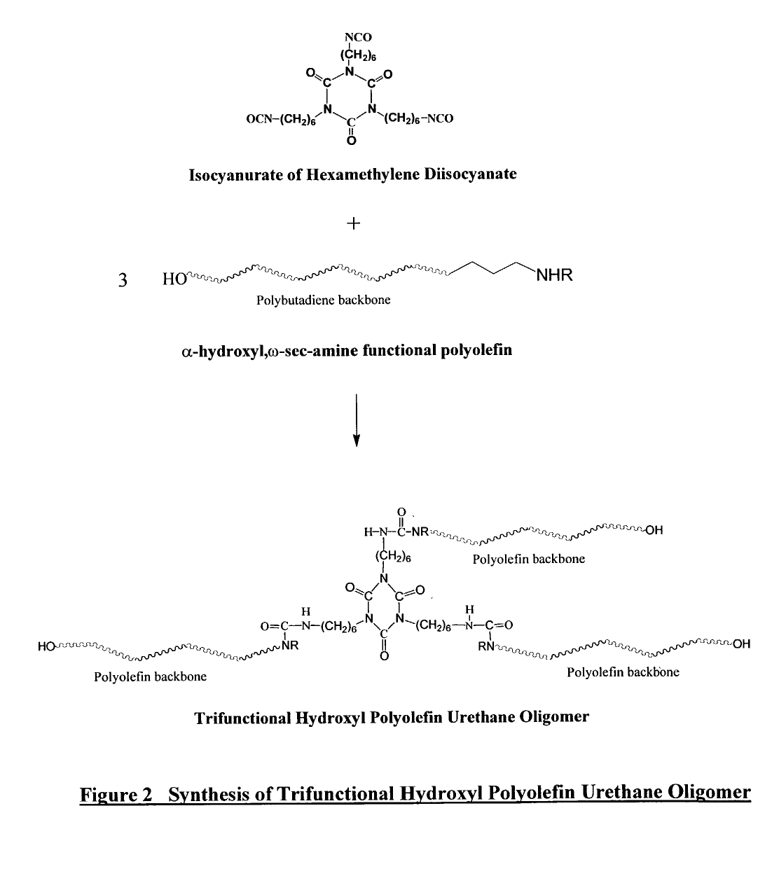

The urethane oligomer adducts which form the embodiment of this invention are illustrated in FIGS. 2, 3, 4, 5 and 6. The tri-functional isocyanaurate of hexamethylene diisocyanate is used in these illustrations, but any of the polyfunctional isocyanates discussed previously may be used.

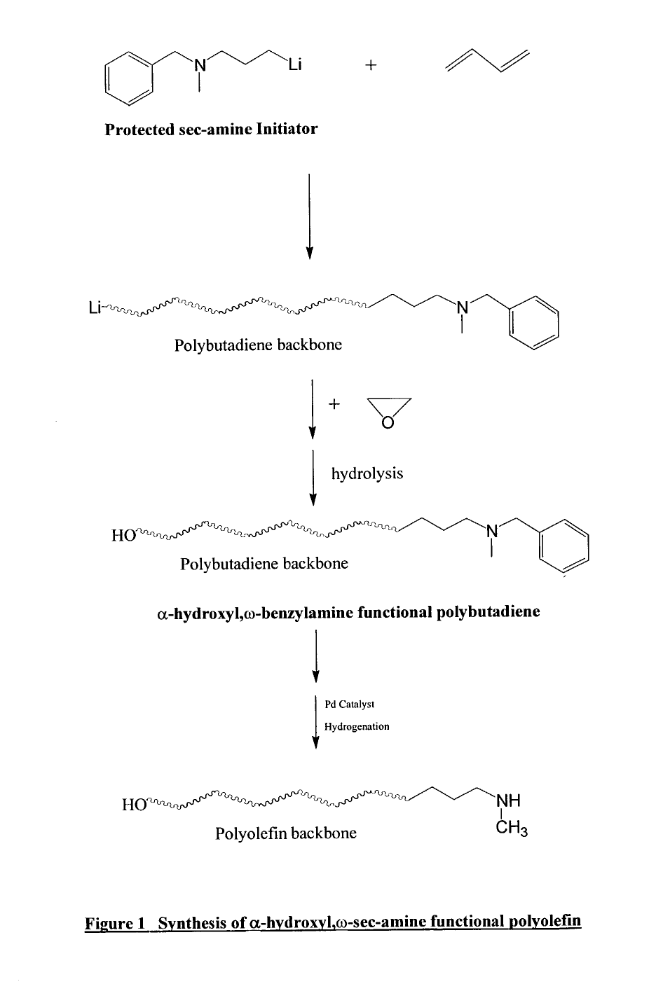

First, an α-hydroxy ω-secondary amino functional polydienes and polyolefins may be prepared as shown in FIG. 1. The heterotelechelic amine functional polymer may be hydrogenated polybutadiene or hydrogenated polyisoprene. The number average molecular weight can range from 1000 to 200,000. If a liquid polymer is desired, the number average molecular weight should be below 10,000 and there should be sufficient pendent vinyl groups in the polybutadiene to prevent crystallization of the polymer upon hydrogenation. FIG. 1 shows the preparation of a primary hydroxyl functional polymer by using ethylene oxide as an electrophile. If desired, a polymer with secondary hydroxyl functionality at the α-terminus of the hetero-telechelic polymer chain can be prepared by reacting the living chain end with propylene oxide.

A hydroxyl functional polyolefin urethane oligomer is prepared as shown in FIG. 2, by reaction of the α-hydroxy ω-secondary amino functional polyolefin prepared as described previously with the isocyanaurate of hexamethylene diisocyanate.

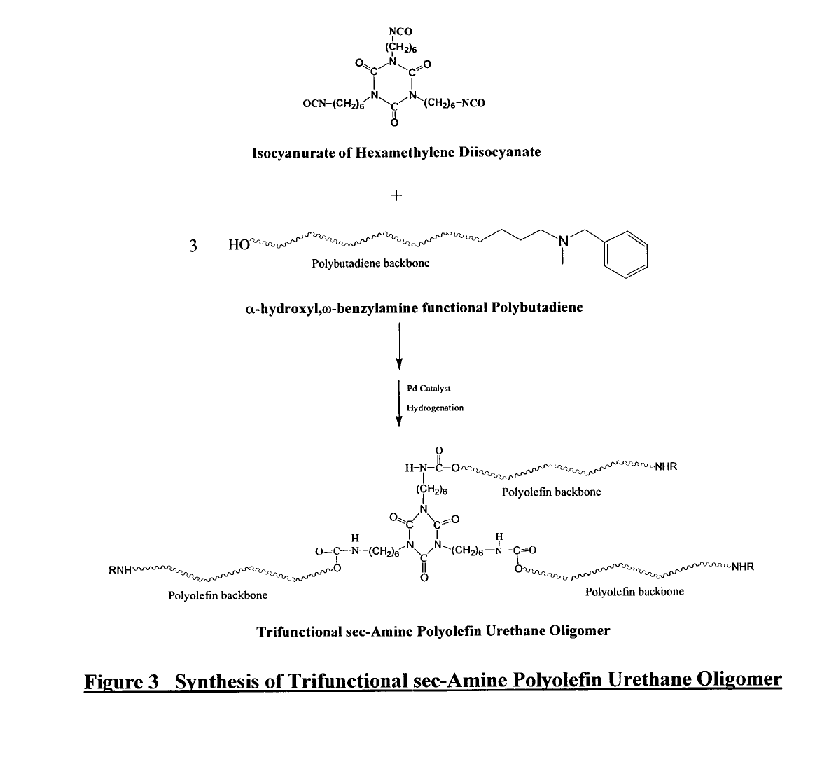

A urethane polyolefin oligomer adduct with secondary amine functionality can be prepared as shown in FIG. 3. The α-hydroxy [symbol] -tertiary amino functional polybutadiene is first reacted with the isocyanaurate, and then hydrogenated using a palladium or other suitable catalyst to hydrogenate the polymer and simultaneously convert the tertiary amine residue from the protected secondary amine initiator to the desired secondary amine functionality, by removal of the benzylic protecting group.

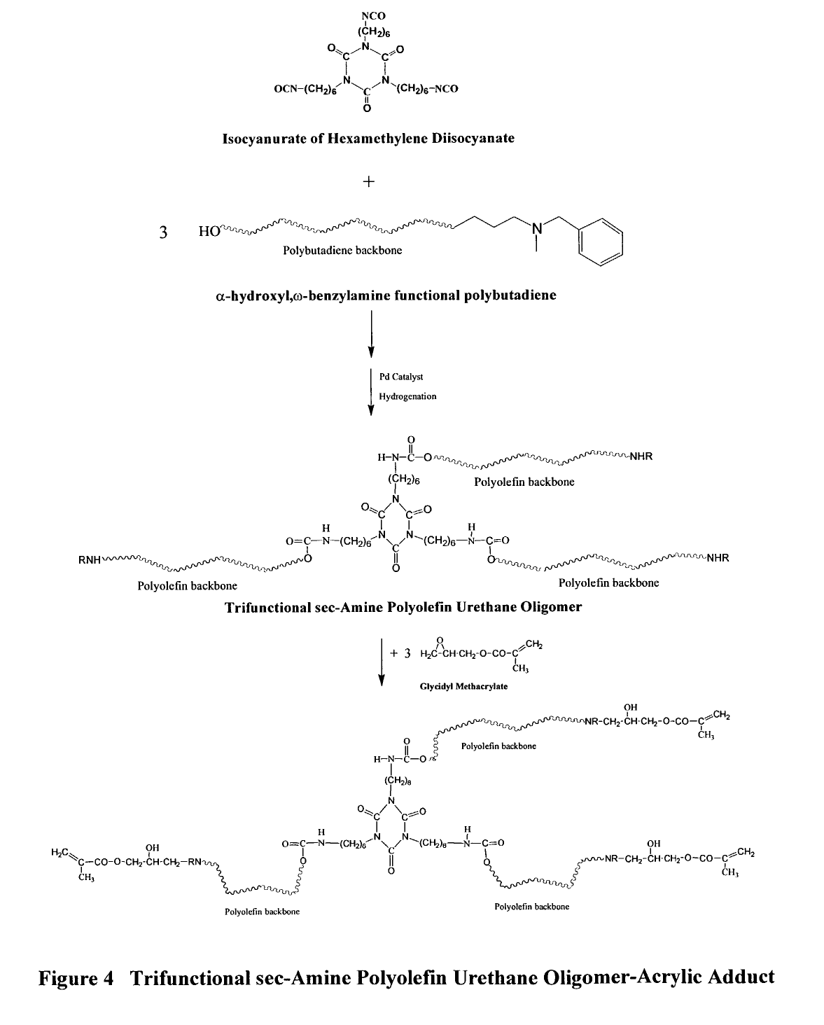

The secondary amine functional urethane oligomer obtained as described by the process of FIG. 3 may be further reacted with glycidyl methacrylate as shown in FIG. 4, to yield a polyacrylic functional polyolefin urethane oligomer which could be useful for reaction with additional acrylic monomers in free radical or radiation curing systems.

Alternatively a polyacrylic functional polyolefin urethane oligomer may be prepared from the Michael addition product of an α-hydroxy, ω-secondary amino functional polyolefin with a suitable polyfunctional acrylate having two or more acrylate functionalities and capable of reacting with the polyolefin via Michael addition. Such acrylates are known in the art and can be generally described as having the formula

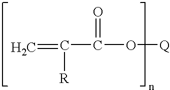

wherein R is hydrogen or methyl, n is ≧2 and Q is an organic group. Preferably n is 2-5, more preferably 2-4 and most preferably 2. It is expected that Q can be any organic group that does not interfere with the Michael addition reaction between the reactive functional group (such as the amine functionality) of the polymer and the acrylate component. Typical Q groups include without limitation polyoxyalkylenes or polyethers, and aliphatic, aromatic and alicyclic groups, and further can include other functionalities, such as epoxy, urethane, polyester, and isocycanate groups as known in the art.

Examples of polyoxyalkylene polyacrylate compounds include, but are not limited to, 1,6-hexanediol diacrylate, 1,4-butanediol diacrylate, ethylene glycol diacrylate, diethylene glycol diacrylate, triethylene glycol diacrylate, tetraethylene glycol diacrylate, tripropylene glycol diacrylate, neopentyl glycol diacrylate, polyethylene glycol diacrylate, 1,3-butylene glycol diacrylate, triisopropylene glycol diacrylate, trimethylolpropane triacrylate, pentaerythritrol monohydroxy triacrylate, trimethylolpropane triethoxy triacrylate, pentaerythritol tetraacrylate, di-trimethylol propane tetraacrylate, and dipentaerythritol (monohydroxy) pentaacrylate, ethoxylated neopentyl glycol diacrylate, propoxylated neopentyl glycol diacrylate, and the like and mixtures thereof.

Other multifunctional acrylate compounds can participate in the Michael addition reaction. These include, but are not limited to, ethoxylated bisphenol A diacrylate, bisphenol A epoxy diacrylate, hexafunctional aromatic urethane acrylate (Ebecryl 220 from UBC Radcure), aliphatic urethane diacrylate (Ebecryl 230 from UBC Radcure), tetrafunctional polyester acrylate (Ebecryl 80 from UBC Radcure), tris (2-hydroxy-ethyl)isocyanurate triacrylate, polyether diacrylates, and the like.

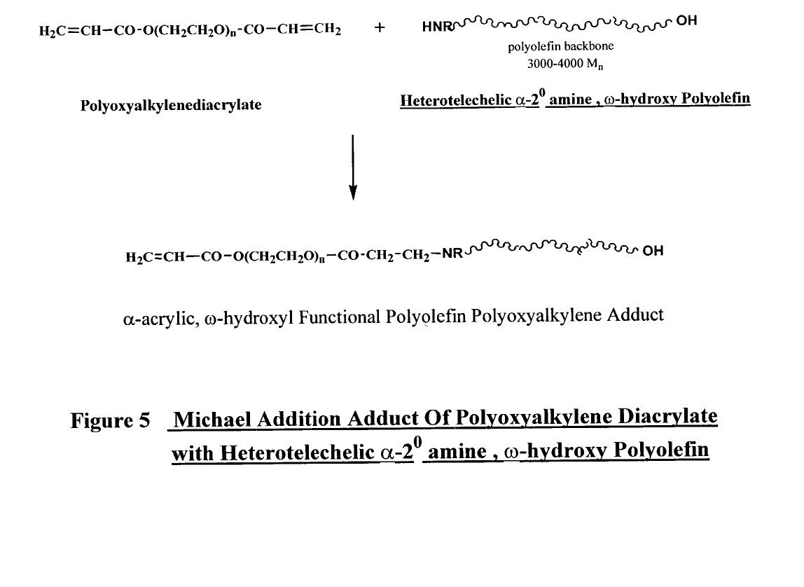

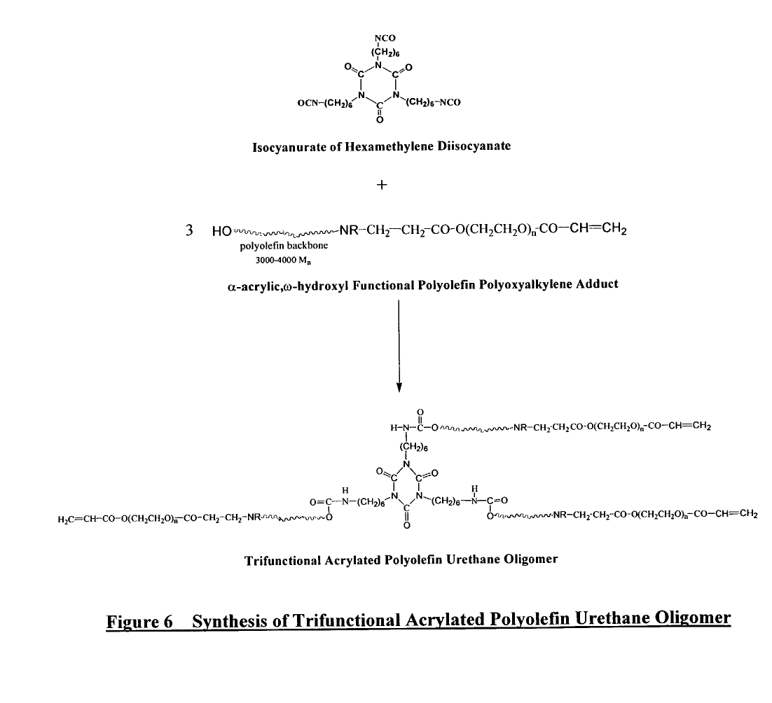

For example, the polyfunctional acrlyate can be polyoxyalkylene diacrylate as in FIG. 5, followed by reaction of this Michael addition product with the isocyanaurate as in FIG. 6. The α-acrylic, ω-hydroxyl functional polyolefins may also be prepared from the Michael addition reaction of α-hydroxy, ω-secondary amino functional polyolefin with other commercially available diacrylate oligomers, such as urethane diacrylates or epoxy diacrylates, followed by reaction with a polyisocyanate.

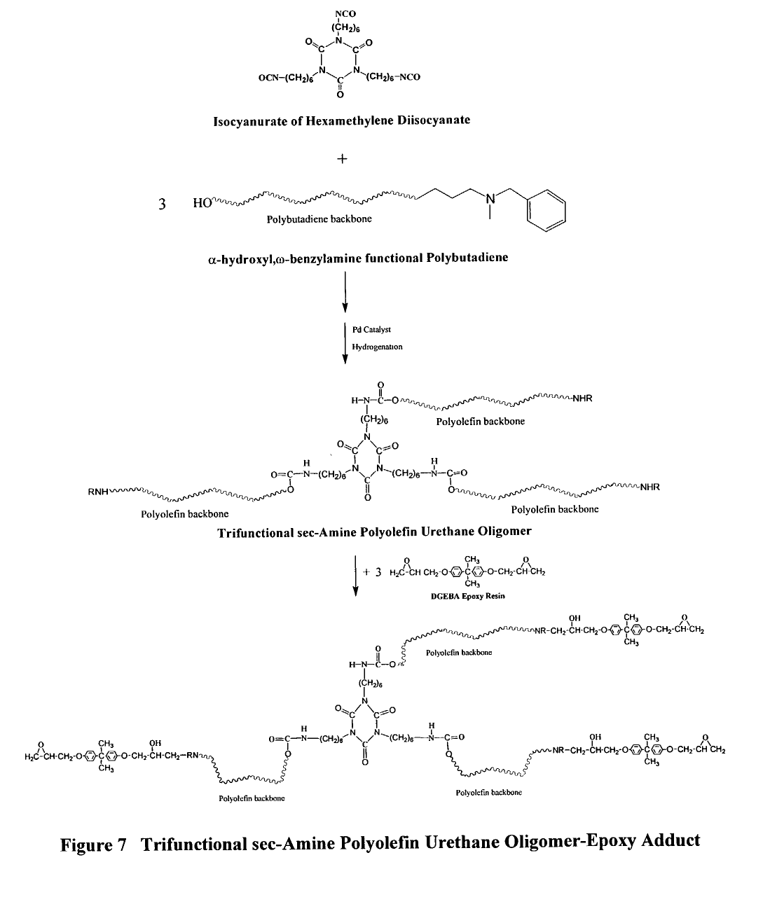

Epoxy functional urethane oligomer adducts can be prepared as shown in FIG. 7, by reaction of the secondary amine functional oligomer with a diepoxide such as the diglycidyl ether of Bisphenol A. Other aromatic alcohol based epoxy resins may be used such as the diglycidyl ether of Bisphenol F or the diglycidyl ether of resorcinol. For improved thermal oxidative and uv stability in the end use application, cycloaliphatic epoxy resins may be used. These epoxy functional oligomers can be used as toughening additives in epoxy coatings, adhesives, or structural composites, where the polyolefin backbone in the oligomer adduct increases the impact strength of the epoxy formulation. The epoxy functional urethane oligomers of the invention can be chain extended or “advanced” by reacting with polyols and/or additional diepoxides, by methods known in the art, as described below.

The adducts such as described above and shown in FIG. 7 may have limited solubility in standard epoxy formulations for adhesives, sealants, coatings and other applications. This limited solubility or compatibility is due to the olefinic nature of the heterotelechelic polyolefin described above. To increase the solubility and hence compatibility of such adducts it is necessary to raise the polarity of the adducts by chain extension, often referred to as “advancement” in epoxy chemistry terminology. This advancement increases the polarity of the oligomer adduct, thereby allowing increased compatability in the end use epoxy formulation. The “advanced” oligomer adducts allow control over “critical molecular weight” (M_{c}), which has implications for toughening/flexibility enhancement, as well as system rheology.

In particular, the advancement of such adducts can be accomplished by reacting the adducts as described above with additional polyhydroxyl group materials and additional polyepoxides such as DGEBA, or other diepoxide compounds as discussed above. The polyhydroxy group materials include, but are not limited to, 1,2-propylene glycol, 1,4propylene glycol, 1,5-pentanediol, 1,2,6-hexanetriol, glycerol, neopentyl glycol, bis(4-hydroxycyclohexyl)-2,2-propane, Bisphenol A or other polyhydroxy aromatic compounds such as resorcinol, 1,3,5-benzenetriol, 1-2-benzenediol, catechin, ethylene glycol, butylene glycol, 1,6-hexylene glycol, trimethylol propane, pentaerythritol, polyester polyols, polyether polyols, urethane polyols, and acrylic polyols. Other aromatic polyols include 4,4′-dihydroxybenzophenone, bis(4-hydroxyphenyl) 1,1-ethane, bis(4-hydroxyphenyl) 1,1-isobutane, bis(4-hydroxyltertiarybutyl-phenyl-2,2-propane, bis(2-hydroxynaphthyl)methane, 1,5-dihydroxynaphthylene, or the like. Particularly attractive to high temperature performance are the diepoxides having biphenyl structure, those based on a fluorene diol, or those based on the liquid crystal α-methyl stilbene. Advancement or chain extension reactions of polyepoxides and polyhydroxy materials are described, e.g., in U.S. Pat. Nos. 3,922,253; 4,001,156; 4,031,050; 4,148,772; 4,468,307; 4,711,917; 4,931,157; and 6,084,036. (Also see Epoxy Resins, Chemistry and Technology, Marcel Dekker, 2nd edition (1988), p. 757). Catalysts, although not required for the chain extension of the epoxy adducts of the invention, can be used to facilitate reactions at room temperature or higher temperatures, if desired. Suitable catalysts include tertiary nitrogen bases, salts, complexes, quaternaries or similar phosphine compounds.

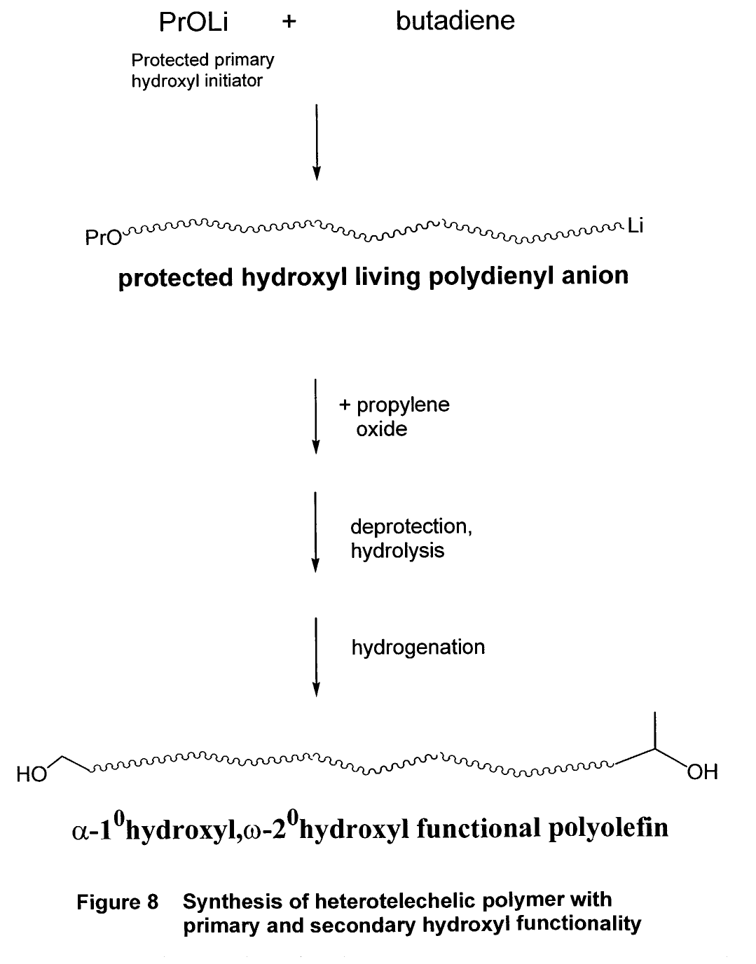

Secondary hydroxyl functional urethane oligomers may be prepared by taking advantage of the relative reactivities of primary and secondary hydroxyl groups with isocyanates. First an α-primary hydroxyl, ω-secondary hydroxyl functional polyolefin is prepared as shown in FIG. 8 by anionic polymerization of a diene such as butadiene with a protected primary hydroxyl functional initiator, followed by reacting the living chain end with propylene oxide, and finally hydrogenation of the diene polymer, using a suitable catalyst such as palladium, to the polyolefin.

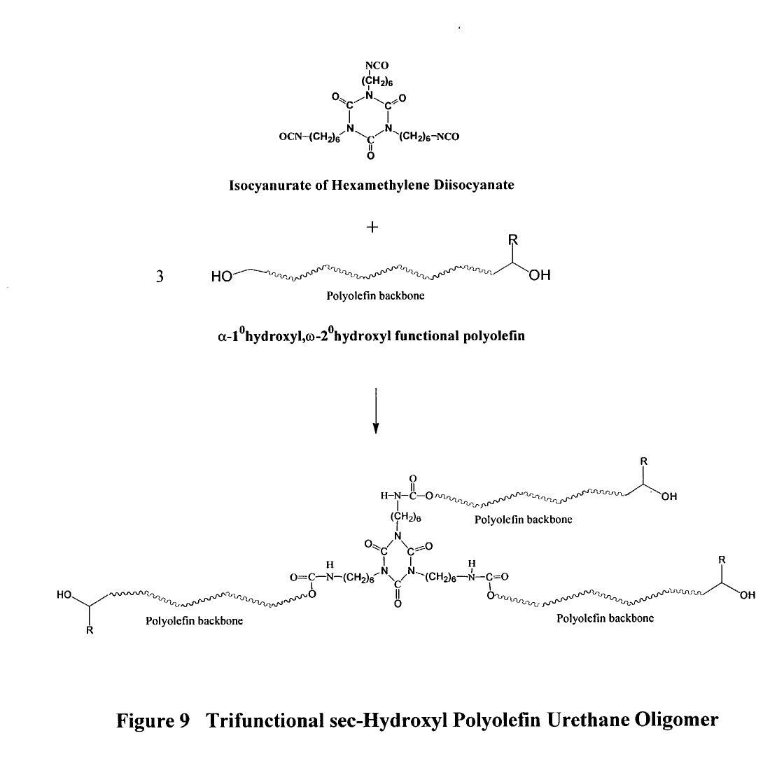

The primary hydroxyl groups will the selectively react with the polyisocyanate to yield the secondary hydroxyl functional urethane oligomer as shown in FIG. 9.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A heterotelechelic polymer comprising
Q-R₁Q wherein R₁ is a polyolefin, at least one Q is a hydroxyl groups and the other Q is an amine groups or is
T(H)ₘ-Z-Qₙ-C-y-W(H)ₖ wherein C represents a hydrogenated or unsaturated block derived by anionic polymerization of one or more conjugated diene hydrocarbons, one or more alkenylsubstituted aromatic hydrocarbons, or mixtures thereof; Y is a branched or straight chain hydrocarbon connecting group which contains 1-25 carbon atoms optionally substituted with aryl or substituted aryl containing lower alkyl, lower alkylthio, or lower dialkylamino groups; Z is a branched or straight chain hydrocarbon connecting groups which contains 3-25 carbon atoms optionally substituted with aryl or substituted aryl containing lower alkyl, lower alkylthio, or lower dialkylamino groups; Q is a saturated or unsaturated hydrocarbyl group derived by incorporation of one or more conjugated diene hydrocarbons, one or more alkenylsubstituted aromatic hydrocarbons, or mixtures thereof; n is a number from 0 to 5; T and W are each independently selected from oxygen and nitrogen, with the proviso that at least one of T or W is oxygen and the other of T or W is nitrogen; and k and m are 1 when T or W is oxygen, and 2 when T or W is nitrogen prepared by anionic polymerization using a functionalized lithium initiator having protected hydroxy functionality.

2. An oligomer prepared by reacting the polymer of claim 1 with a polyisocyanate.
